(19) United States
(12) Patent Application Publication
(10) Pub. No.: US 2014/0267049 A1
(43) Pub. Date: Sep. 18, 2014

(54) LAYERED AND SPLIT KEYBOARD FOR FULL 3D INTERACTION ON MOBILE DEVICES

(71) Applicants: Lenitra M. Durham, Beaverton, OR (US); David M. Durham, Beaverton, OR (US)

(72) Inventors: Lenitra M. Durham, Beaverton, OR (US); David M. Durham, Beaverton, OR (US)

(21) Appl. No.: 13/840,963

(22) Filed: Mar. 15, 2013

(51) Int. Cl. G06F 3/02

(52) U.S. Cl. CPC G06F 3/02
USPC 345/168

(57) ABSTRACT

Systems and methods may provide for displaying a plurality of keyboards in a three-dimensional (3D) environment via a screen of a mobile device and identifying a selected keyboard in the plurality of keyboards based at least in part on a first user interaction with an area behind the mobile device. Additionally, an appearance of the selected keyboard may be modified. In one example, a selected key in the selected keyboard is identified based at least in part on a second user interaction and the mobile device is notified of the selected key.

### CROSS-REFERENCE TO RELATED APPLICATIONS

The present application is related to International Patent Application No. PCT/US11/67376 filed on Dec. 27, 2011.

### TECHNICAL FIELD

Embodiments generally relate to mobile device interactivity. More particularly, embodiments relate to the use of layered and split keyboards in three-dimensional (3D) environments to enhance the interactivity of mobile devices.

### BACKGROUND

Conventional smart phones may have screens (e.g., displays) that are small relative to the content being displayed on the screen. For example, a typical software keyboard may be difficult to view on a standard smart phone screen in its entirety. Accordingly, some solutions may provide multiple several keyboard variations such as an upper case keyboard, a lower case keyboard, a number keyboard, and a special character keyboard, in order to reduce the amount of keyboard content displayed at any given moment in time. Even with such keyboard variations, however, the occlusion of other content by on-screen keyboards may lead to a negative user experience. Moreover, switching between, and typing on, the keyboard variations may still be difficult from the user's perspective, particularly when the buttons/keys of the keyboard are small relative to the fingers of the user.

### BRIEF DESCRIPTION OF THE DRAWINGS

The various advantages of the embodiments will become apparent to one skilled in the art by reading the following specification and appended claims, and by referencing the following drawings, in which:

FIG. 1 is a perspective view of an example of a three-dimensional (3D) virtual desktop environment having a plurality of stacked keyboards according to an embodiment;

FIG. 2 is a perspective view of an example of a 3D virtual environment having a split keyboard according to an embodiment;

FIG. 3 is a flowchart of an example of a method of facilitating keyboard interactions in a 3D virtual environment according to an embodiment; and

FIG. 4 is block diagram of an example of a mobile device according to an embodiment.

### DESCRIPTION OF EMBODIMENTS

Turning now to FIG. 1, a mobile device 10 is shown, wherein the mobile device 10 has a screen 12 (e.g., liquid crystal display/LCD, touch screen, stereoscopic display, etc.) that is viewable by a user 14. The mobile device 10 may be, for example, a smart phone, mobile Internet device (MID), smart tablet, convertible tablet, notebook computer, or other similar device in which the size of the screen 12 is relatively small. In the illustrated example, a 3D environment 16 is displayed on the screen 12 so that it appears to be located at some distance behind the mobile device 10 when viewed from the front of the mobile device 10. The 3D environment 16 may include, for example, a virtual desktop environment in which multiple windows 18 (18a, 18b) appear to be much larger than the screen 12. The location of the windows 18 could be “in-air” (e.g., floating) or “pinned” to some external surface behind the mobile device 10 such as a physical desktop, wall, etc. The illustrated 3D environment 16 also includes a plurality of keyboards 20 (20a-20e) that are displayed in a stacked/layered arrangement. Of particular note is that displaying the plurality of keyboards 20 in the 3D environment may enable the keyboards 20 to appear much larger to the user and easier to manipulate (e.g., select and/or type on). The location of the keyboards 20 may also be in-air or pinned to an external surface.

In general, the user 14 may hold the mobile device 10 in one hand and use another “free hand” 22 to interact with the 3D environment 16. The user interactions with the 3D environment 16 may involve activity related to, for example, keyboard selection operations, typing operations, cursor movement operations, click operations, drag and drop operations, pinch operations, selection operations, object rotation operations, and so forth, wherein the mode of conducting the operations may vary depending upon the circumstances. For example, if the 3D environment 16 is pinned to an external surface such as a physical desktop, the user 14 might select the keyboards 20 by tapping on the external surface with the index (or other) finger of the free hand 22. In such a case, the mobile device 10 may include a rear image sensor and/or microphone (not shown) to detect the tapping (e.g., user interaction) and perform the appropriate click and/or selection operation in the 3D environment 16. For example, the rear image sensor might use pattern/object recognition techniques to identify various hand shapes and/or movements corresponding to the tapping interaction. Similarly, the microphone may be able to identify sound frequency content corresponding to the tapping interaction. Other user interactions such as drag and drop motions and pinch motions may also be identified using the rear image sensor and/or microphone.

Thus, if the illustrated keyboard 20a (e.g., lowercase keyboard) is currently the active keyboard (e.g., in the forefront of the other keyboards) and the index finger of the free hand 22 taps on the external surface at a location corresponding to the keyboard 20c (e.g., number keyboard), the mobile device 10 may respond by making the selected keyboard 20c the active keyboard (e.g., changing the depth and/or visibility of the selected keyboard, moving it to the forefront of the other keyboards and/or otherwise modifying its appearance). Such an approach may enable the external surface to provide tactile feedback to the user 14. If, on the other hand, the 3D environment 16 is an in-air environment (e.g., not pinned to an external surface), tactile feedback may be provided by another component such as an air nozzle, on the device, configured to blow a puff of air at the free hand 22 in response to detecting the user interaction.

The user 14 may also move the index finger of the free hand 22 to the desired location and use the hand holding the mobile device 10 to interact with a user interface (UI) of the mobile device 10 such as a button 24 to trigger one or more operations in the 3D environment 16. The button 24 may therefore effectively function as a left and/or right click button of a mouse, with the free hand 22 of the user 14 functioning as a coordinate location mechanism of the mouse. For example, the button 24 might be used as an alternative to tapping on the external surface in order to click on or otherwise select one or more of the keyboards 20. Thus, the user 14 may simply move the free hand 22 to point to the desired keyboard 20 in the 3D environment 16 and use the other hand to press the button 24 and initiate the click/selection operation.

As already noted, the 3D environment 16 may alternatively be implemented as an in-air environment that is not pinned to a particular external surface. In such a case, the movements of the free hand 22 may be made relative to in-air locations corresponding to the keyboards 20 and other objects in the 3D environment 16. The mobile device 10 may also be equipped with an air nozzle (not shown) that provides tactile feedback in response to the user interactions with the 3D environment 16.

The illustrated mobile device 10 may also enable typing on selected keyboards in the 3D environment. For example, gestures by the free hand 22 may be used to identify selected keys on the selected keyboard, wherein notifications of the selected keys may be provided to various programs and/or applications (e.g., operating system/OS, word processing, messaging, etc.) on the mobile device 10. The hand holding the mobile device 10 may also be used to implement typing operations by, for example, pressing the button 24 to verify key selection, and so forth.

The illustrated mobile device 10 may also enable implementation of a unique approach to pan and zoom operations. In particular, the user 14 can pan (e.g., scroll left, right, up or down) across the 3D environment 16 by simply moving the free hand 22 in the desired direction to the edge of the scene, wherein the rear image sensor may detect the motions of the free hand 22. Another approach to panning may be for the user 14 to tilt/move the mobile device 10 in the direction of interest, wherein the mobile device 10 may also be equipped with a motion sensor and/or front image sensor (not shown) that works in conjunction with the rear image sensor in order to convert movements of the mobile device 10 into pan operations. Either approach may enable the virtual 3D environment 16 displayed via the screen 12 to appear to be much larger than the screen 12.

Moreover, the motion sensor and/or front image sensor may work in conjunction with the rear image sensor in order to convert movements of the mobile device 10 into zoom operations. In particular, the front image sensor may determine the distance between the mobile device 10 and the face of the user 14, and the rear image sensor could determine the distance between the mobile device 10 and the free hand 22 of the user 14 and/or external surface, wherein changes in these distances may be translated into zoom operations. Thus, the user 14 might zoom into the plurality of keyboards 20 by moving the mobile device 10 away from the face of the user 14 and towards the plurality of keyboards 20 (e.g., changing the depth of the keyboards, as with a magnifying glass).

Similarly, the user 14 may zoom out of the plurality of keyboards 20 by moving the mobile device towards the face of the user 14 and away from the plurality of keyboards. Such an approach to conducting zoom operations may further enable relatively large virtual environments to be displayed via the screen 12. Moreover, by basing the 3D environment modifications on user interactions that occur behind the mobile device 10, the illustrated approach obviates any concern over the fingers of the free hand 22 occluding the displayed content during the user interactions.

FIG. 2 shows another 3D environment 26 in which a split keyboard 28 (28a, 28b) is displayed via the screen 12 of the mobile device 10. In the illustrated example, a first portion 28a of the split keyboard 28, which may be selected from a plurality of layered keyboards, is displayed at a first depth in the 3D environment 26. Additionally, a second portion 28b of the split keyboard 28 may be displayed at a second depth in the 3D environment 26, wherein the second depth is greater than the first depth. Moreover, the second portion 28b may be significantly larger in size than it would be at the lesser depth (e.g., closer to the user). Accordingly, the user 14 may use the free hand 22 to type on the second portion 28b of the split keyboard 28 and use the thumb of the hand holding the mobile device 10 to type on the first portion 28a of the split keyboard 28. Of particular note is that reducing the amount of keyboard content to be displayed at the closer depth enables the keys of the illustrated first portion 28a to be made larger and substantially easier to select with the thumb of the hand holding the mobile device 10. Moreover, increasing the size of the second portion 28b enables the keys of the illustrated second portion 28b at the greater depth to also be made larger and substantially easier to select with the free hand 22.

Turning now to FIG. 3, a method 30 of facilitating keyboard interactions in a 3D environment is shown. The method 30 may be implemented in a mobile device such as the mobile device 10 (FIGS. 1 and 2) as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 30 may be written in any combination of one or more programming languages, including an object oriented programming language such as Java, Smalltalk, C++ or the like and conventional procedural programming languages, such as the “C” programming language or similar programming languages.

In general, a device portion 32 of the method 30 may involve implementing keyboard operations in the 3D environment based on device movements, and an interaction portion 34 of the method 30 may involve implementing keyboard operations in the 3D environment based on user interactions. Illustrated processing block 36 provides for acquiring frame buffer data, wherein the frame buffer data may be associated with the pixel data used to render one or more keyboard image/video frames of the 3D environment via a screen of the mobile device. The location and orientation of an external surface may be determined at block 38. Alternatively, the keyboards may be rendered at an in-air location in which the determination at block 38 might be bypassed.

Block 40 can provide for adjusting the perspective and location of the frame buffer data so that it is consistent with the orientation of the external surface. Thus, for example, if the external surface is a physical desktop positioned at a certain angle (e.g.,) 45° to the user, the frame buffer data may also be tilted at the same/similar angle. A movement and/or re-orientation of the mobile device may be detected at block 42, wherein detection of the movement might be achieved by a using one or more signals from a motion sensor, rear image sensor, front image sensor, etc., of the mobile device, as already discussed. Illustrated block 44 updates the frame buffer based on the device movement/re-orientation to display the keyboards and/or keyboard portions at the appropriate depth and/or visibility in the 3D environment. Therefore, the update at block 44 may involve panning left/right, zooming in/out, maintaining the proper perspective with respect to the external surface orientation, and so forth. The update at block 44 may therefore involve modifying the keyboard appearance on a keyboard-by-keyboard basis as well as with respect to the plurality of keyboards as a whole.

In the interaction portion 34 of the method 10, block 46 may provide for detecting a hand/finger position (e.g., in-air, on device, on external surface), wherein a cursor movement operation may be conducted at block 48 based on the hand/finger position. Additionally, one or more signals from the rear image sensor, microphone and/or mobile device (e.g., UI, button, etc.) may be used to identify one or more finger gestures on the part of the user at block 50. The identification at block 50 may therefore be based on a user interaction with the area behind the mobile device and/or a user interaction with the mobile device itself. If it is determined at block 52 that a gesture has been detected, illustrated block 54 performs the appropriate action in the 3D environment. Thus, block 54 might involve identifying a selected keyboard, identifying one or more selected keys on a selected keyboard, and so forth. In the case of a selected key, block 54 may also provide for notifying the mobile device of the selected key. Illustrated block 56 provides for determining whether an exit from the virtual environment interaction process has been requested. If either no exit has been requested or no gesture has been detected, the illustrated method 30 repeats in order to track device movements and hand movements, and updates the 3D environment accordingly.

FIG. 4 shows a mobile device 60. The mobile device 60 may be part of a platform having computing functionality (e.g., personal digital assistant/PDA, laptop, smart tablet), communications functionality (e.g., wireless smart phone), imaging functionality, media playing functionality (e.g., smart television/TV), or any combination thereof (e.g., mobile Internet device/MID). The mobile device 60 could be readily substituted for the mobile device 10 (FIGS. 1 and 2), already discussed. In the illustrated example, the device 60 includes a processor 62 having an integrated memory controller (IMC) 64, which may communicate with system memory 66. The system memory 66 may include, for example, dynamic random access memory (DRAM) configured as one or more memory modules such as, for example, dual inline memory modules (DIMMs), small outline DIMMs (SODIMMs), etc.

The illustrated device 60 also includes a input output (JO) module 68, sometimes referred to as a Southbridge of a chipset, that functions as a host device and may communicate with, for example, a front image sensor 70, a rear image sensor 72, an air nozzle 74, a microphone 76, a screen 78, a motion sensor 79, and mass storage 80 (e.g., hard disk drive/HDD, optical disk, flash memory, etc.). The illustrated processor 62 may execute logic 82 that is configured to display a plurality of keyboards in a 3D environment via the screen 78, identify a selected keyboard in the plurality of keyboards based at least in part on a first user interaction with an area behind the mobile device 60, and modify an appearance of the selected keyboard. The logic 82 may alternatively be implemented external to the processor 62. Additionally, the processor 62 and the JO module 68 may be implemented as a system on chip (SoC).

The appearance of the selected keyboard and/or plurality of keyboards may also be modified based on movements of the mobile device 60, wherein one or more signals from the front image sensor 70, the rear image sensor 72, the microphone 76 and/or the motion sensor 79 might be used to identify the user interactions and/or the mobile device movements. In addition, user interactions with the mobile device 60 may be identified based on one or more signals from a UI implemented via the screen 78 (e.g., touch screen) or other appropriate interface such as the button 24 (FIG. 1), as already discussed. Moreover, the logic 82 may use the nozzle 74 to provide tactile feedback to the user in response to the user interactions.

Moreover, selected keys in selected keyboards may be identified based at least in part on user interactions, wherein the user interactions may be with the area behind the mobile device and/or the mobile device itself. Additionally, a first portion of a selected keyboard may be displayed at a first depth in the 3D environment and a second portion of the selected may be displayed at a second depth in the 3D environment in order to facilitate easier typing operations from the perspective of the user.

### Additional Notes and Examples

Example one may include a mobile device having a screen and logic to display a plurality of keyboards in a three-dimensional (3D) environment via the screen. The logic may also identify a selected keyboard in the plurality of keyboards based at least in part on a first user interaction with an area behind the mobile device, and modify an appearance of the selected keyboard.

Example two may include an apparatus having logic, at least partially comprising hardware, to display a plurality of keyboards in a 3D environment via a screen of a mobile device and identify a selected keyboard in the plurality of keyboards based at least in part on a first user interaction with an area behind the mobile device. The logic may also modify an appearance of the selected keyboard.

Additionally, the logic of examples one and two may identify a selected key in the selected keyboard based at least in part on a second user interaction, and notify the mobile device of the selected key. In addition, the second user interaction of example one may be with one or more of the mobile device and the area behind the mobile device. In addition, the logic of example one may display a first portion of the selected keyboard at a first depth in the 3D environment, and display a second portion of the selected keyboard at a second depth in the 3D environment, wherein the second depth is to be greater than the first depth.

Example three may include a non-transitory computer readable storage medium having a set of instructions which, if executed by a processor, cause a mobile device to display a plurality of keyboards in a 3D environment via a screen of the mobile device. The instructions, if executed, may also cause the mobile device to identify a selected keyboard in the plurality of keyboards based at least in part on a first user interaction with an area behind the mobile device, and modify an appearance of the selected keyboard.

Additionally, the instructions of example three, if executed, may cause the mobile device to identify a selected key in the selected keyboard based at least in part on a second user interaction, and notify the mobile device of the selected key. In addition, the second user interaction of example three may be with one or more of the mobile device and the area behind the mobile device. Additionally, the instructions of example three, if executed, cause may the mobile device to display a first portion of the selected keyboard at a first depth in the 3D environment, and display a second portion of the selected keyboard at a second depth in the 3D environment, wherein the second depth is to be greater than the first depth. In addition, the instructions of example three, if executed, may cause the mobile device to identify a selected key in the first portion of the selected keyboard based at least in part on a third user interaction with the mobile device, and identify a selected key in the second portion of the selected keyboard based at least in part on a fourth user interaction with the area behind the mobile device. Additionally, the instructions of example three, if executed, may cause the mobile device to change one or more of a visibility and a depth of the selected keyboard in the 3D environment to modify the appearance of the selected keyboard. In addition, the instructions of example three, if executed, may cause the mobile device to change a depth of the plurality of keyboards in the 3D environment based at least in part on a fifth user interaction with the mobile device. Additionally, the plurality of keyboards of example three may be displayed in a stacked arrangement.

Example four may involve a computer implemented method in which a plurality of keyboards are displayed in a 3D environment via a screen of a mobile device. The method may also provide for identifying a selected keyboard in the plurality of keyboards based at least in part on a first user interaction with an area behind the mobile device, and modifying an appearance of the selected keyboard.

Additionally, the method of example four may further include identifying a selected key in the selected keyboard based at least in part on a second user interaction, and notifying the mobile device of the selected key. In addition, the second user interaction of example four may be with one or more of the mobile device and the area behind the mobile device. Additionally, the method of example four may further include displaying a first portion of the selected keyboard at a first depth in the 3D environment, and displaying a second portion of the selected keyboard at a second depth in the 3D environment, wherein the second depth is greater than the first depth.

Thus, techniques described herein may enable a full keyboard interaction experience using a small form factor mobile device such as a smart phone. By using 3D display technology and/or 3D rendering mechanisms, it is possible to enable the user to interact through a mobile device, looking at its screen, while interacting with the space above, behind, below and beside the device's screen. In addition, the screen may be viewable only to the individual looking directly into it, therefore enhancing privacy with respect to the user interactions. Additionally, many different keyboard variations such as, for example, emoticon keyboards, foreign language keyboards and future developed keyboards, may be readily incorporated into the 3D environment without concern over space limitations, loss of precision or interaction complexity.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A mobile device comprising:
a screen; and
logic to,
display a plurality of keyboards in a three-dimensional (3D) environment via the screen;
identify a selected keyboard in the plurality of keyboards based at least in part on a first user interaction with an area behind the mobile device; and
modify an appearance of the selected keyboard.

2. The mobile device of claim 1, wherein the logic is to,
identify a selected key in the selected keyboard based at least in part on a second user interaction; and
notify the mobile device of the selected key.

3. The mobile device of claim 2, wherein the second user interaction is to be with one or more of the mobile device and the area behind the mobile device.

4. The mobile device of claim 1, wherein the logic is to,
display a first portion of the selected keyboard at a first depth in the 3D environment; and
display a second portion of the selected keyboard at a second depth in the 3D environment, wherein the second depth is to be greater than the first depth.

5. An apparatus comprising:
logic, at least partially comprising hardware, to,
display a plurality of keyboards in a three-dimensional (3D) environment via a screen of a mobile device;
identify a selected keyboard in the plurality of keyboards based at least in part on a first user interaction with an area behind the mobile device; and
modify an appearance of the selected keyboard.

6. The apparatus of claim 5, wherein the logic is to,
identify a selected key in the selected keyboard based at least in part on a second user interaction; and
notify the mobile device of the selected key.

7. The apparatus of claim 6, wherein the second user interaction is to be with one or more of the mobile device and the area behind the mobile device.

8. The apparatus of claim 5, wherein the logic is to,
display a first portion of the selected keyboard at a first depth in the 3D environment; and
display a second portion of the selected keyboard at a second depth in the 3D environment, wherein the second depth is to be greater than the first depth.

9. The apparatus of claim 8, wherein the logic is to,
identify a selected key in the first portion of the selected keyboard based at least in part on a third user interaction with the mobile device; and
identify a selected key in the second portion of the selected keyboard based at least in part on a fourth user interaction with the area behind the mobile device.

10. The apparatus of claim 5, wherein the logic is to change one or more of a visibility and a depth of the selected keyboard in the 3D environment to modify the appearance of the selected keyboard.

11. The apparatus of claim 5, wherein the logic is to change a depth of the plurality of keyboards in the 3D environment based at least in part on a fifth user interaction with the mobile device.

12. The apparatus of claim 5, wherein the plurality of keyboards are to be displayed in a stacked arrangement.

13. A non-transitory computer readable storage medium comprising a set of instructions which, if executed by a processor, cause a mobile device to:
display a plurality of keyboards in a three-dimensional (3D) environment via a screen of the mobile device;
identify a selected keyboard in the plurality of keyboards based at least in part on a first user interaction with an area behind the mobile device; and
modify an appearance of the selected keyboard.

14. The medium of claim 13, wherein the instructions, if executed, cause the mobile device to:
identify a selected key in the selected keyboard based at least in part on a second user interaction; and
notify the mobile device of the selected key.

15. The medium of claim 14, wherein the second user interaction is to be with one or more of the mobile device and the area behind the mobile device.

16. The medium of claim 13, wherein the instructions, if executed, cause the mobile device to:
display a first portion of the selected keyboard at a first depth in the 3D environment; and
display a second portion of the selected keyboard at a second depth in the 3D environment, wherein the second depth is to be greater than the first depth.

17. The medium of claim 16, wherein the instructions, if executed, cause the mobile device to:
identify a selected key in the first portion of the selected keyboard based at least in part on a third user interaction with the mobile device; and
identify a selected key in the second portion of the selected keyboard based at least in part on a fourth user interaction with the area behind the mobile device.

18. The medium of claim 13, wherein the instructions, if executed, cause the mobile device to change one or more of a visibility and a depth of the selected keyboard in the 3D environment to modify the appearance of the selected keyboard.

19. The medium of claim 13, wherein the instructions, if executed, cause the mobile device to change a depth of the plurality of keyboards in the 3D environment based at least in part on a fifth user interaction with the mobile device.

20. The medium of claim 13, wherein the plurality of keyboards are to be displayed in a stacked arrangement.

21. A method comprising:
displaying a plurality of keyboards in a three-dimensional (3D) environment via a screen of a mobile device;
identifying a selected keyboard in the plurality of keyboards based at least in part on a first user interaction with an area behind the mobile device; and
modifying an appearance of the selected keyboard.

22. The method of claim 21, further including:
identifying a selected key in the selected keyboard based at least in part on a second user interaction; and
notifying the mobile device of the selected key.

23. The method of claim 22, wherein the second user interaction is with one or more of the mobile device and the area behind the mobile device.

24. The method of claim 21, further including:
displaying a first portion of the selected keyboard at a first depth in the 3D environment; and
displaying a second portion of the selected keyboard at a second depth in the 3D environment, wherein the second depth is greater than the first depth.
